(19) United States
(12) Patent Application Publication
(10) Pub. No.: US 2004/0153382 A1
(43) Pub. Date: Aug. 5, 2004

(54) System and method for determining discrepancies in a communications system

(76) Inventors: Richard Boccuzzi, Ashland, MA (US); Theodore Czotter, Holliston, MA (US); Thomas Nolting, Holliston, MA (US); Mark Garvey, Hanover, MA (US); Rastislav Nukovic, Foxboro, MA (US); Jeremy Warren, Chestnut Hill, MA (US)

Correspondence Address: Brian P. Hopkins, Mintz, Levin, Cohn, Ferris,, Glovsky and Popeo, P.C., One Financial Center, Boston, MA, 02111, US

(21) Appl. No.: 10/356,254

(22) Filed: Jan. 31, 2003

(51) Int. Cl. G06F 17/60

(52) U.S. Cl. 705/34

(57) ABSTRACT

Systems and methods for determining discrepancies of a communication system including at least one data source, at least one data parser and/or data adaptor, at least one data loader and/or data abstractor, at least one database abstraction, at least one data store, an invoice management module, a revenue and cost management module, an intercarrier traffic management module, a secondary user-interface table and a user interface.

### FIELD OF THE INVENTION

The present invention is directed to systems and methods for identifying cost, network element and billing record discrepancies in a communication system. More particularly, the present invention is directed to systems and methods for examining data of a communications system to identify charges incurred unnecessarily or in error by relating invoice, inventory, usage, and billing data. In doing so, the system identifies overcharges and undercharges and where carriers lose capital revenue.

### BACKGROUND OF THE INVENTION

Revenue leakage is a persistent problem for telecommunications carriers. Revenue leakage may be defined as the loss of revenues or profits due to systemic inefficiencies related to failures to correctly match rates or costs with services actually provided, to accurately measure the quantity of services provided, and to properly characterize the nature of the traffic exchanged over the network. Errors in order-entry, inaccurate traffic measurement and disconnects are just a few examples of how revenue leakage causes carriers to lose millions of dollars each month. Because modern telecommunications networks typically have been patched together over time using different communications protocols and operating systems, such problems are not easily identified, and specific errors can persist indefinitely.

Revenue leakage has a significant impact on carriers' profitability. In 2000, worldwide telecom service revenues were nearly $875 billion. Some have estimated that revenue leakage is equal to between 2% and 11% of total carrier revenues. Thus, lost revenues industry-wide may range from $17.5 billion on the low end to as high as $96 billion. Revenue leakage is likely to become more serious as the volume and complexity of products, services and network traffic continues to increase, particularly in large enterprise retail and wholesale market segments.

Currently, telecommunications carriers address revenue leakage by performing annual or one-time system and process audits performed generally by large accounting and consulting firms. Typical practices include switch-to-bill verifications, interconnect billing audits, inventory and provisioning audits, and traffic and usage analysis. Additionally, there are a number of software vendors who address selected aspects of the revenue assurance market. For example, companies such as Vibrant, TEOCO, and BroadMargin have deployed invoice automation and analysis tools in the CLEC marketplace. Test call generators such as BoardRoom focus on the integrity of the switch- to-bill process, and inventory reconciliation companies such as CoManage and T-Soft have developed tools to address discrepancies in the inventory databases.

These methods fall short of providing an on-going comprehensive solution because they are one-time in nature and focused on single pieces of a much larger problem. What is missing is a all-inclusive solution: one that uses existing OSS (Operational Support System) and BSS (Business Support System) platforms and enables them to be related so that discrepancies can not only be identified and quantified, but also more easily resolved. In short, the solution would need to be easily integrated into existing legacy systems and able to interact with all the relevant invoice, usage, inventory and retail billing systems that are spread across the networks of carriers and their trading partners.

### SUMMARY OF THE PRESENT INVENTION

The present invention addresses the above issues and presents a novel system for determining revenue leakage in a communications system. The system according to the present invention may handle voluminous records of different data types and stores and analyzes data from disparate sources. By accurately capturing invoice data, the present invention may compare network inventory and usage data against invoice data. The information may be retrieved from a database and displayed in reports that are displayed in a Web browser, for example, on the client machine. The reports, accordingly, derived from electronic and paper (manually entered) invoices, may provide a comprehensive view of all electronic invoice activity.

Components of the present invention may effectively extract, condition, consolidate, and report on four expanding sources of data: cost data, revenue data, data from usage records, and network inventory data. To that end, the present invention may use data sources in the operational environment of a telecommunication carrier: network element cost data contained in thousands of detailed and cryptic monthly carrier invoices found in different locations, mediums, and formats; revenue data in the form of retail and wholesale customer monthly billing and collection data; usage records copied and extracted from the mediation and/or switch usage measurement platforms of a customer; and network inventory data found in multiple provisioning and facility assignment systems.

Invoice, inventory, usage and billing data may be collected, parsed, and stored. Next, transformation from ambiguous, meaningless data to succinct business and financial information may occur by relating these disparate elements. By leveraging reference information, the data may be further enriched (e.g., Industry Network Assignments, Rate/Tariff, Contract Terms, Network Inventory abstracts, and the like). Business rules may be applied to answer custom-designed questions, and analytic processing routines may be applied to solve complex business problems and to ensure the quality of the billing activities of the carrier.

Accordingly, in a first aspect of the present invention, a system for determining discrepancies in a communication system includes an invoice management module and a validation module. This embodiment may also include a reporting module, a discrepancy analytical module, an inter-carrier traffic analysis module,

In another aspect of the present invention, a system for determining discrepancies in a communications system includes a first module for maintaining persistent data for the system, a second module for processing invoice data, a third module having an application for allowing a user via a user interface to view data and a client module for accessing the application and user interface to view data. The modules may be a computer system, server system and/or workstation.

In yet another aspect of the present invention, a method for determining discrepancies in a communications network includes retrieving invoice data, parsing the invoice data into a plurality of first records, verifying the invoice data in the first records and loading the first records into a first database.

In the above aspect, parsing may include reading a specification file associated with the type of data of the invoice records and dividing the invoice records into a plurality of formatted discrete fields. Parsing may also include any one or more of the following: classifying each invoice record into an invoice record type, generating at least one token for each invoice record, determining a database table to assign each invoice record, extracting a first field required for the database table from each invoice record, writing the first field to an output file, and loading the output file into a primary database.

In another aspect of the present invention, a method for determining discrepancies in a communications system includes retrieving communication data from at least one data source, parsing the communication data, analyzing the parsed data and reporting a result of the analysis. Parsing may include one or more of the following: breaking the communication data down into a plurality of corresponding records and usage files which describe a structure and form of the communication data, enriching the communication data with reference data.

The above method aspect may also include storing the plurality of records on a relational database.

In yet another aspect of the present invention, a system for determining discrepancies of a communication system includes at least one data source, at least one data parser and/or data adaptor, at least one data loader and/or data abstractor, at least one database abstraction, at least one data store, an invoice management module, a revenue and cost management module, an intercarrier traffic management module, a secondary user-interface table and a user interface.

In still yet another aspect of the present invention, a system for determining discrepancies in a communications network includes retrieving means for retrieving invoice data, parsing means for parsing the invoice data into a plurality of first records, verifying means for verifying the invoice data in the first records and loading means for loading the first records into a first database.

Still other aspects of the present invention include computer readable media having computer instructions provided thereon for enabling a computer system to perform one or more of the method aspects set out above (either alone or in combination), and also to application program aspects for enabling a computer system to perform any one or more of the method aspects set out above (either alone or in combination).

Accordingly, the above objects, advantages, features and aspects of the present invention will become clearer with references to the figures (a brief description of which is set out below) and the following detailed description of the preferred embodiments.

### BRIEF DESCRIPTION OF THE DRAWINGS

FIG. 1 illustrates an overview of the system according to an embodiment of the present invention.

FIG. 2 illustrates a systems flow and technology overview of the system according to an embodiment of the present invention.

FIG. 3 illustrates a logical architecture of a parser and loader processes for an embodiment according to the present invention.

FIG. 4 illustrates the ICTA process for an embodiment according to the present invention.

FIGS. 5-8 are example screenshots of output generated by the system according to some of the embodiments of the present invention.

### DETAILED DESCRIPTION OF THE PREFERRED EMBODIMENTS

The following are definitions which may be associated with the present invention that are generally used in the detailed description of the preferred embodiments.

Access Charges: Fees paid by subscribers and long-distance carriers for their use of the local exchange in placing long distance calls.

Aging: The status of the invoice as it moves from one status to another (for example, from a new invoice to a disputed invoice).

AMA: Automatic Message Accounting.

BAN: Billing Account Number.

BDT: Billing Data Tape.

BTN: Billing Telephone Number.

CABS: Carrier Access Billing System.

CDR: Call Detail Record. A service feature in which call data on a specific telephone extension or group of subscribers are collected and recorded for cost-of-service accounting purposes.

Call Record: Recorded data pertaining to a single call.

Carrier: See its synonym, common carrier.

Central Office: The site that contains the local telephone company's equipment that routes calls to and from customers. This site also contains equipment that connects customers to long distance services and Internet Service Providers.

Checksum: Checksums, the sum of data items, are stored or transmitted with data and are intended to detect data integrity problems.

Call Record: Recorded data pertaining to a single call.

CLEC: Competitive Local Exchange Carrier. A CLEC is a wireline-based local exchange (switched and non-switched) carrier serving in a geographical area that is already served by an incumbent local exchange carrier.

Common Carrier: A telecommunications company providing communications transmission services. Its synonym is carrier.

CLEC: Competitive Local Exchange Carrier

Convergence: The merging of different technologies such as telephony, computers, and cable.

CPN: Calling Party Number or the originating number as defined in the Revenue Assurance system.

Dedicated Line: A communications circuit or channel provided for the exclusive use of a particular subscriber. Dedicated lines are often used to move large amounts of data between computers.

Discrepancy: An inconsistency that is detected between an invoice charge and an expected element value.

Discrepancy Tracking: A sub-component of Invoice Tracking, Discrepancy Tracking tracks and displays system-identified discrepancies for an invoice from open to closed states.

Dispute: Refers to payments being withheld and action taken to challenge the validity of one or several charge elements on an invoice.

Dispute Substantiation: Documentation of dispute including all original source data (for example, CABS source data would include the Pack Sequence number, the Record Sequence number, and the line number).

Dispute Tracking: Monitor, report and update the status, progress, and assignment of a specific dispute from initiation to resolution. Allows a manager to measure primary operational metrics (for example, aging, time from initiation to resolution, and assignments.)

DSL: Digital Subscriber Line. Provides instant Internet and network access at speeds up to 50 times faster than a 28.8 Kbps modem on a standard analog phone line. Because DSL sends data and voice over the same line, one can talk on the phone while connected to the internet.

DUF: Daily Usage File.

End Office: End Office (EO) is a switching system that establishes line-to-line, line-to-trunk, and trunk-to-line connections, and provides dial tone to customers.

IEC or IXC: Interexchange Carrier. Synonymous in common usage with “long distance carrier.”

ILEC: Independent Local Exchange Carrier.

Inbound: Refers to calls entering the network of the Revenue Assurance customer.

Individual Charge Threshold: The amount by which the system recognizes an individual charge as a discrepancy.

Internet Traffic Analysis: Identification of dial-up data access numbers and measurement of network interconnection traffic volumes to these “suspected” Internet Service Providers.

Interconnection Carrier Traffic Report: Monthly reporting of carrier Minutes of Use (MOU) and peg count call levels that are exchanged between the CLEC and identified facility-based interconnecting networks. Balance ratios are calculated for reciprocal compensation bill validation.

Interexchange Carrier: See IXC.

IntraLATA Calling: Calls originating and terminating in the same service area (LATA).

Intrastate InterLATA Calling: Refers to calls originating in one service area (LATA) and terminating in another service area (LATA) but these calls are in the same state, for example, Austin to Dallas or Austin to Houston.

Invoice Browser: Read-only navigation, query and reporting on secondary tables.

Invoice Explorer (formerly invoice browser): Enables an end user of present system to look at everything in the user interface, even hidden details. See original invoice in its original structure as stored in the primary tables in the database. Not rolled up by USOC.

Invoice Tracking: Process of invoice to monitor, report, and update the status and assignment from receipt to closure.

ISDN: Integrated Services Digital Network. A standardized design for simultaneous voice, data and video signals over a pair of twisted wires, the most common type of customer line in the telephone network.

IXC: Interexchange Carrier. Synonymous in common usage with “long distance carrier.”

Jurisdictional Measurements: Measurement of toll and local interconnection traffic levels and calculation of actual Percent Interstate Usage (PIU), Percent Intrastate Toll, and Percent Local Usage (PLU) factors.

LATA: Local Access Transport Area. Defines that area, in a state served by a Bell telephone company, in which, under current federal Telecommunications Act rules, the company can provide service. Each service area may include one or more area codes or share a common area code.

LCC: Line Class Code. The Line Class Code is used to establish the routing service. A customized routing plan is negotiated as part of the Network Design Request (NDR) process that takes place between an ILEC and a CLEC.

LD: Long Distance.

LEC: A Local Exchange Carrier provides local exchange services including the Bell Companies and all independent telcos.

LERG: Local Exchange Routing Guide. The Local Exchange Routing Guide provides a listing of routing data obtained from the Routing Database System (RDBS) into which data are entered by Local Service Providers (LSPs) and/or their agents. The LERG Routing Guide reflects information contained in the database as of the run date of the LERG production cycle. With few exceptions, this is the last working day of each month. The LERG Routing Guide reflects the “current” state of active network data and also reflects “future” activity within the North American Numbering Plan (NANP).

Line-level Usage Validation: Line-level usage validation is functionality that categorizes, summarizes, and compares usage from two sources for a billing period by individual telephone numbers. The comparison produces discrepancies, indexed by Working Telephone Number (WTN), billing period, and other key fields, which are reported in Peg Count and MOU differences.

LLR: Line Loss Report.

Local Exchange Routing Guide: See LERG.

MOU: Minutes of Use. The aggregated total of minutes for a set of calls.

NPA: Numbering Plan Area.

Number Portability: Number portability is the term used to describe the capability of individuals, businesses, and organizations to retain their existing telephone number(s)—and the same quality of service—when switching to a new local service provider.

OCC: Other Charges and Credits.

OCN: Operating Company Number. A telephone industry code used to identify a telephone company.

Originating: In the Revenue Assurance system, originating and terminating refers to the endpoints of a call. That is, originating refers to the caller making the call and terminating refers to the person receiving the call.

Outbound: Refers to calls leaving the network of the Revenue Assurance customer.

Peg Count: The number of Call Detail Records.

Percent Interstate Usage: PIU.

Rate Center: A Rate Center is technically the approximate midpoint of what is usually called a Rate Exchange Area, although the term Rate Center also has been used synonymously with the geographic area itself.

RBOC: Regional Bell Operating Company. In general, this refers to one of seven corporations created to provide local exchange service as part of AT&T's 1984 divestiture (Ameritech, Bell Atlantic, BellSouth, Nynex, Pacific Bell, Southwestern Bell, US WEST).

RBS: Retail Billing System.

RDBS: Routing Data Base System.

Resale: The ability of an entity that has not constructed a network of its own to offer to end users services located on a network built by another.

Site Map: A site map or site index is a visual model of a Web site's content. The site map allows the users to navigate through the site to find the information they seek.

Terminating: In the Revenue Assurance system, originating and terminating refers to the endpoints of a call. That is, originating refers to the caller making the call and terminating refers to the person receiving the call.

Time-of-Day Report: This reporting module identifies and reports the day-evening-night-weekend usage volumes for originating and terminating traffic.

Trending and Usage Patterns: Reports on statistics and time series measurements pinpoint interconnection traffic patterns and show changes in traffic distributions.

Unbundling: Disaggregated features, functions, and capabilities of the local network. Disaggregation is intended by regulators to maximize competitive entry.

UNE: Unbundled Network Element.

UNE-P: Unbundled Network Element-Platform.

Usage: Measurement of service utilization. Comes in the form of CDRs (AMA, BAF, EMI, SS7). In the Revenue Assurance system, reported usage is provided by a third-party source. Invoiced usage can be rated and billed on the invoice. Invoiced usage can be aggregated.

USOC: Universal Service Ordering Code.

Web Browser: Client software, communicating with a Web server, navigates a web of interconnected documents on the World Wide Web.

Web Server: A powerful computer that is connected to the Internet or an intranet that stores files and displays them to persons accessing them via hypertext transfer protocol (http).

WTN: Working Telephone Number.

Revenue Assurance Systems/Methods

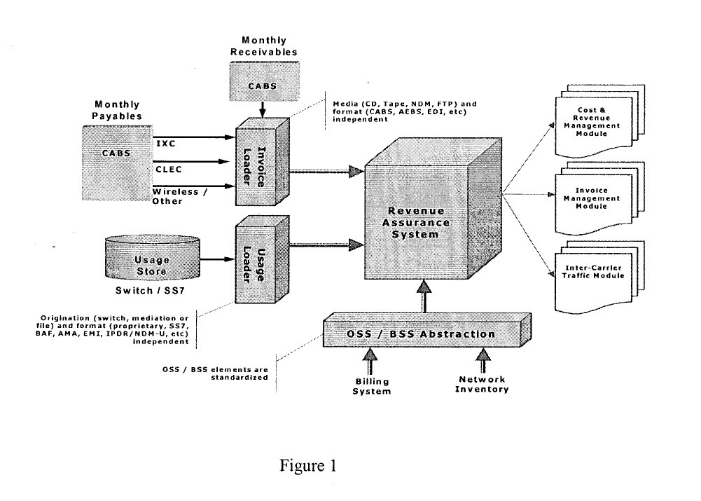

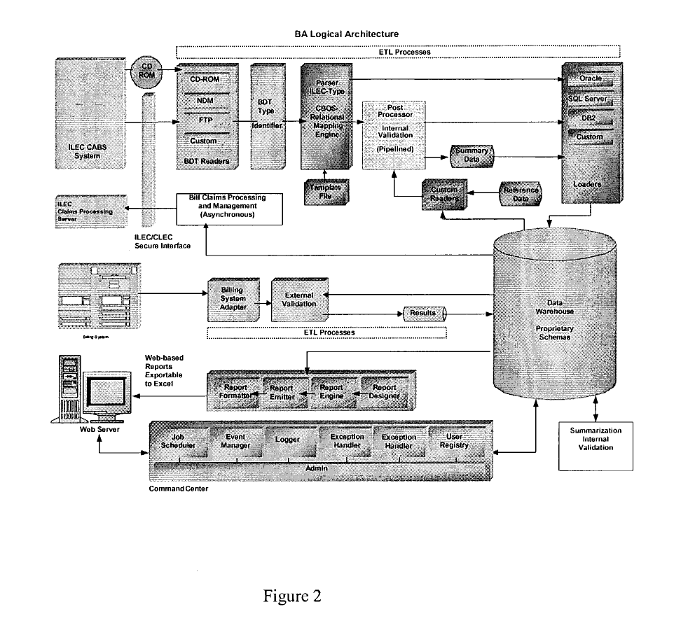

FIG. 1 illustrates an embodiment of the present invention where monthly payables CABs data, which may include data associated with IXC, CLEC or other invoiced communication billing data (e.g., wireless), may be loaded using an invoice loader. Monthly receivable CABs data may also be loaded via the invoice loader. Usage data may be loaded using usage loader as well. FIG. 2 illustrates a Logical System Architecture Overview according to another embodiment of the present invention.

Using references data (abstraction) of the operational support system (OSS) and billing support system (BSS), the present invention may use one or more modules to load, analyze and report revenue discrepancies and validation of invoices, rates, and usage.

For the system to be easily integrated into a customer's existing operational environments, a “Command Center” feature for overall control of all the systems functions and processes may be preferably included. The Command Center allows system administrators to configure various data sources and log files, establish security policies, view file-processing status, and establish error-handling policies. All subsystems communicate with the Command Center to provide real-time system monitoring.

One embodiment of the system according to the present invention may automate the following processes and tasks:

Data Retrieval. The product reads network, billing and usage data from a variety of sources, including monthly invoices (CABS data), call records and usage files, and customer billing information derived from retail billing and accounting systems.

Preferably, an embodiment of the present invention provides a system which supports an unlimited number of external systems and has the capability to load several sources of data elements simultaneously by distributing processing across multiple application servers. The present system is preferably compatible with existing legacy systems and requires generally no external changes to those systems. The system generally uses only relevant information from complex OSS and BSS platforms and may asynchronously receive invoices, usage and reference data. The system may be capable of acquiring data from various sources including CD-ROM, FTP, NDM and manual input. In situations not covered by these scenarios, data retrieval can be accomplished through a custom reader.

The present invention automates the invoice administration process by reading, parsing, loading and processing CABS and/or BDT invoices, miscellaneous machine-readable electronic invoices, and existing customer invoice data stores. Also provided may be a means to manually load paper invoices. In addition, the system may read, process, bin and load a customer's usage measurement system and reference data sources.

Data Parsing, Standardization and Storage. Parsing modules may break original data streams down into corresponding records which describe the structure and form of the source data. As the parsers restructure the data into records, the data may be enriched using the client's reference data (e.g., tariff and rate information). Data enrichment generally reduces the number of reference look-ups that the system may need to perform when producing reports. Accordingly, data enrichment increases the overall system's efficiency and throughput.

Once the data has been retrieved and parsed, the data may be transformed into an abstracted/standardized format and stored on a relational database by loaders. Such relational databases may be, for example, Oracle 8.x and MS SQL Server 7.0 databases. In one embodiment of the present invention, the system matches records from the system database to those in the clients' source systems. By matching such records and identifying places where they disagree, the system identifies resource and billing discrepancies. The results of these comparisons are stored (e.g., back in the system database) for historical and reporting purposes.

Data Analysis and Reporting. Generally, analysis occurs where the software applies customer determined business rules to link/correlate data objects. The specific processing logic for linking unrelated data is performed through the use of database triggers, stored procedures or through program routines within the data loaders. Examples of data links the system performs include linking cost objects to their corresponding revenue objects. Business rules may also be applied to ensure that cost and revenue objects are computed correctly. Business objects may also be linked to corresponding cost or margin objects (for example).

Reporting. Preferably, once all the data has been processed, it is abstracted into a set of database views that simplifies reporting of information. These views also serve to help retain the unique and proprietary data schema that is core to the underlying system. Customers may view data through Java Server Pages (JSPs) that may be modified or extended, depending on customer requirements. Additionally, since a user interface is preferably based on internet-web technology, it is easily deployed to any workstation with an installed web browser.

The present system allows users to design and publish their own reports in both Web-friendly and Excel formats (for example). Because the reporting module uses a commercial, relational database as its source, the reporting package may be replaced with one of the clients' choosing.

Product Modules

Invoice Management Module. This module preferably may provide a streamlined, electronic, scalable view to manage and report business and financial measurements of incoming and outgoing invoice activity. The module's flexible framework enables automated loading of any electronic invoice, independent of type, and for non-electronic invoices, manual loading of invoice data is provided.

Summary bill views may present high-level information on invoices by carrier, state, billing account number (BAN), year and month. The present system also preferably enables the user to view every individual charge contained in a stored invoice, and the logical invoice structure as originally submitted by the carrier. Selection and display criteria allow users to preferably quickly access any invoice information. In that regard, users are able to view and analyze invoice data trends.

Detailed views may provide “drill down” functionality to examine specific details of any invoice charges. Current views are provided for Payments, Adjustments, OCCs (NRC), Recurring, Usage, Late Payment, Taxes and Surcharges. Additionally, each area can be viewed, summarized and trended, and easily exported from the user interface to Excel (CSV) and PDF formats. Each report page may be book-marked by the end user for convenient and easy access to the most relevant reports.

One advantage of the Invoice Management module according to one embodiment of the present invention is it that it may provide a single repository and a common, comprehensive view of all electronic invoice activity (BDT, non-BDT electronic, other invoice data) for a customer billing operations team. By acquiring, conditioning and normalizing all the disparate invoice records into a single data store, the Invoice Management module provides a vital information resource for a carrier's cost management, revenue assurance, and network financial functions.

Revenue and Cost Management Module. The Revenue and Cost Management Module may organize and analyze invoice, usage, and network inventory data to detect revenue and cost opportunities. The module preferably may perform the following functions: analytics and rate validation. Specifically, with regard to analytics, the present module preferably provides customizable, organized and logical views of invoice activities as it relates to service levels and network usage. The module may also include the ability to analyze itemized charges on both incoming and outgoing invoices and to detect and display revenue/cost trends at a detailed or macro level. With regard to rate validation, the module compares invoiced rates with those stored in the product rate book to identify inconsistencies that may result in under- or over-charges for services actually delivered.

Inter-Carrier Compensation Traffic Analysis (ICTA) Module. This module may draw upon customer call records (CDR) or usage measurement systems to consolidate and generate traffic analysis reports that relate measured traffic data to corresponding invoice data. Specifically, this module may provide detailed access to network usage data that identifies key inter-connect data including parties involved, locations, and type of traffic being exchanged between the customer and its trading partners. The ICTA module also provides product management, regulatory and legal personnel with accurate network traffic data for use in the resolution of billing disputes.

In a preferred embodiment of the present invention, the web-based interface provides a practical view of traffic patterns and trends generated by one or more of the modules that can be applied to affect changes in terms for ratio and factor based billing found in carrier contracts.

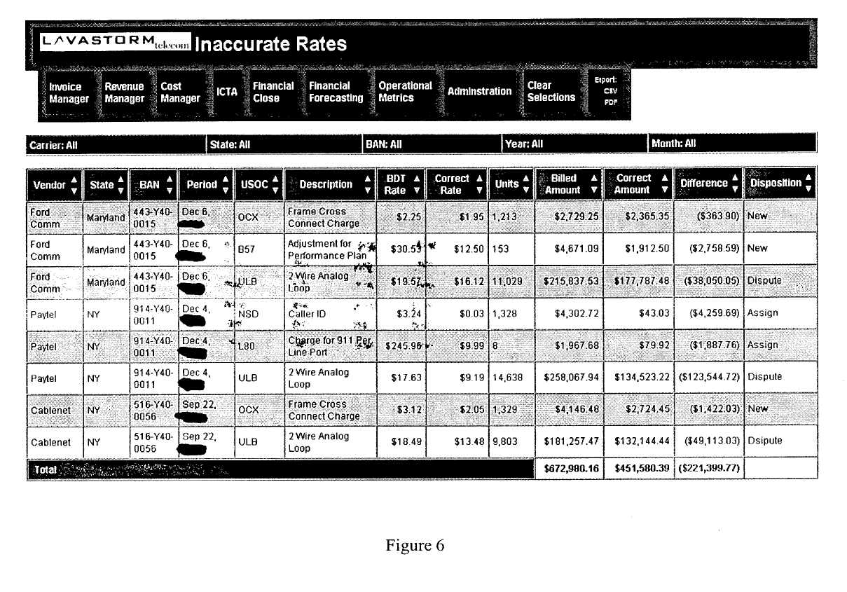

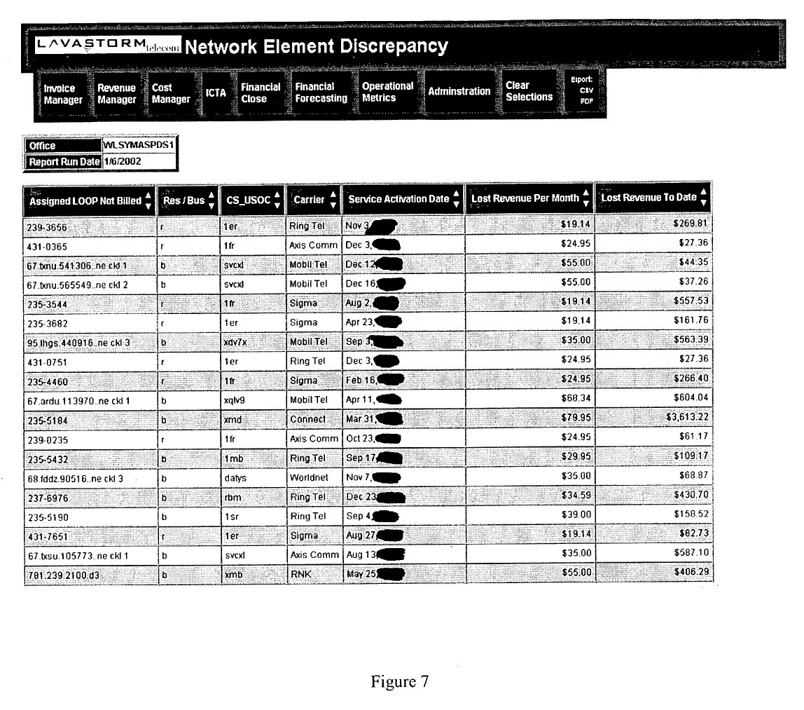

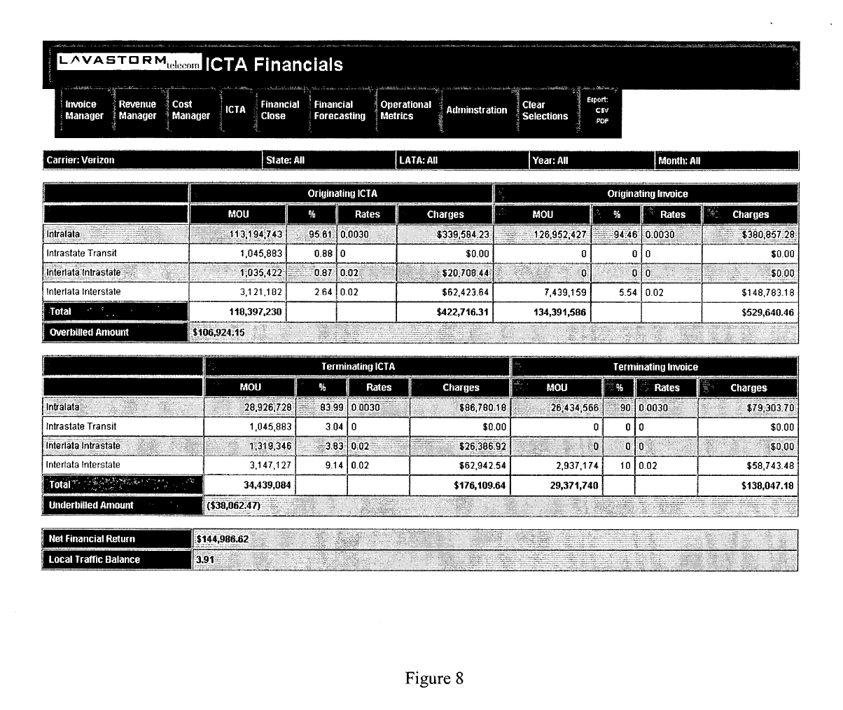

Reports. The following table illustrates exemplary reporting categories that may be generated by the system according to the present invention. See FIGS. 6-9 for example screenshots of some web-based, for example, reporting.

| Reports | Description |
|---|---|
| Interconnection | Monthly reporting of local and access Minutes of Use |
| Carrier Traffic | (MOU), peg count, and corresponding balance of |
| | traffic levels. As needed carrier-to-carrier ratio and |
| | volume distribution factors can be calculated and |
| | reported. |
| Transit and | Discrete identification of originating and terminating |
| Time-of-Day | transit traffic levels by carrier, switch, and location. |
| Measurements | Additionally, time-of-day traffic distributions can be |
| | figured and compared to terms of local |
| | interconnection agreements. |
| Jurisdictional | Measurement of toll and local interconnection traffic |
| Measurements | levels and calculation of actual Percent Interstate |
| | Usage (PIU), Percent Intrastate Toll, and Percent |
| | Local Usage (PLU) factors. |
| Internet Traffic | Identification of dial-up data access numbers and |
| Analysis | analysis of traffic volumes to these “suspect” ISPs. |
| Traffic | Identification and quantification of traffic types and |
| Characterization | users interconnecting with the carriers network. |
| | Examples include wireless, “toll free,” Directory |
| | Assistance, Operator Services, and chat line traffic. |

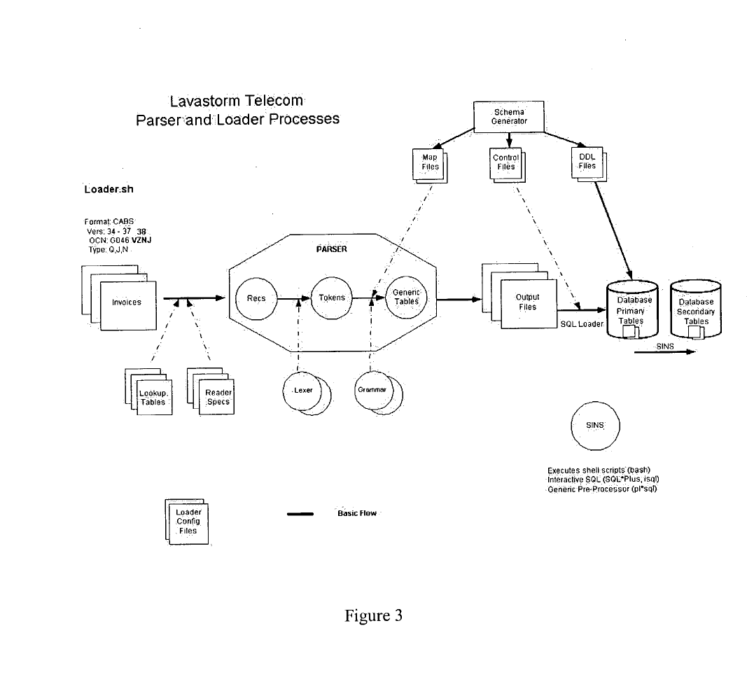

Parser and Loader Processes (FIG. 3). The system and method according to the present invention parses and transforms electronic and manual invoices and loads them into a database so that the data can be easily accessed from a desktop workstation. Preferably, the information is made available for various analysts and managers in an easy-to-understand user format that corresponds to the paper and electronic invoices.

The system according to an embodiment of the present invention may handle voluminous records and different data types. In addition to serving as an Invoice Browser, the end user may drill down on the data to examine details and analyze Intercarrier Traffic data for trends. Key functionality may include reports that show charge discrepancies between data that is reported in the invoice versus what is measured on the network. The user can display trend information graphically in the UI as well.

The invoice parser according to the present invention may extract information from paper (manually entered) and electronic invoices, and transform the data into output files that are loaded into a database using a bulk loader (e.g., such as Oracle Bulk Loader or SQL Loader). The electronic invoices are typically delivered in to the parser in BDT format, however, the invoice parser may also accept Call Record Details (CDRs).

The output files in the database are may be made readable for the user interface, although several steps may generally be performed prior to the information from the invoices being extracted, parsed, loaded and displayed.

Acccordingly, in one embodiment of the present invention, a script file (loader.sh) drives the loader and parser processes. The invoices may be loaded and the system may determine the invoice type using lookup tables. To that end, the loader.sh script looks at the Loader Configuration file to organize the invoices and to identify which type of Reader Specification file to use.

The Reader Specification files may specify record positions and record titles for each type of CABS file. Preferably, the Lookup files are used to identify the file types that distinguish records by their formats, version numbers, vendors (e.g., by OCNs), and geographical regions. These Reader Specification files, which represent each record type, may be modified easily to accommodate future versions of CABS invoices.

The parser may use the map files to map data to database columns and indicate which fields should be pulled into the database. Preferably, there exists one map file for every table to be populated, and a set of map files for every type and version of invoices to be parsed. One set of map files may be available for each Reader Specification file.

The invoice parser may include preferably four logical components: a reader, a lexer, a grammer component and an emitter. The reader may read the BDT file line-by-line and may parse the raw BDT records into formatted data structures. The Lexar component may take the parsed BDT record and classify it by record type, and may also generate one or more tokens (identifiers). The Grammar component may take classified records and determine what database table, if any, to populate with the record. The Emitter component may take the record and the database table name, extract the fields from the record that are required by the table, and then may write the table record to the output files.

With the Grammer component, the database table determination may be based generally on the context of the records that come before and after it. The Grammar files may be read in using Bison, for example, which pulls the data into a structure that corresponds to the proper form. Bison is a general-purpose parser generator that converts a grammar description for an LALR context-free grammar into a C program to parse that grammar.

The output files, which now may have a one-to-one relationship with the original invoice records, may be loaded into the primary database using a bulk loader.

The primary database records may be aggregated and formatted using SINS Processing (see below) to create user interface secondary tables. In anticipation of new record types and versions, the present invention may include a Database Schema Generator, which may use control files to generate new DDL files for a new database schema.

Expression Utilities. Because source data is extremely diverse, expression utilities may be used to modify input files using one or more business rules before they are loaded into the database. At a minimum, input data may come from a billing system, a switch, or from usage processors. Because the input files from these sources may have column values that are tab delimitated, certain operations may be performed programmatically to produce more meaningful output files. These output files may be designed to contain data based on agreed-upon business rules (for example). The data from these output files may be extracted and presented in the reports after data are calculated from the primary and secondary UI tables.

Expression Utilities may be used to modify input files. The below listed table gives a description of example Expression Utilities which may be used in the present invention.

| Utility | Description |
|---|---|
| Agg | Takes in a pre-sorted file and passes the lines to the |
| | expression output system indicating when groupings of the |
| | lines ends, thus, allowing the user to manipulate output |
| | aggregations. |
| CAT | Programmatically combines files together so the files are |
| | concatenated. This utility assumes that the files have the same |
| | structure. Might be useful if additional operations are |
| | necessary. These can be done against one long file. |
| Filter | Another term for transforming file data with a simple pass |
| | through operation. For example, the output file could have |
| | one column removed if instructed. |
| Join | Takes two input files and examine sets of presorted delimited |
| | data. One can find what is in one set of data but not in the |
| | second set of data. An inner join can be added to find all like |
| | components, for example. Using the Join utility is beneficial |
| | when performing lookups. The Join utility is more powerfully |
| | used if two data sources are compared. |
| Sort | The Sort utility sorts delimited or undelimited text files based |
| | on a selected set of columns. |
| Usage | Combines two components, CAT and Sort. This is useful |
| Proc | when examining data for a month or longer. |
| xRef | Similar to Join but it can work with different input files. |
| | Effective when used for more than two input data sources. |
| | Our system can accommodate up to 32 different sources. For |
| | example, the Revenue Assurance system can look at files 1 |
| | and 2 and produce file 3 that has specifically requested output |
| | information. |

An Xreference utility may provide a way to do joins between multiple (>=2) input sources. The primary use of this may be to replace the functionality of the text utility comm. For each input row the expression specified by the -x or -X option may be evaluated and the result of the evaluation may then be used to compare the rows.

SINS Processing. SINS processing describes how customer data, such as invoices may be processed. For example, invoice data types like UNE, Inter-carrier, Switched Access, Resale, and UNE-P from selected Operating Company Numbers (OCNs), may be processed with the data separated into directories by data type. To process the electronic data, the following steps may be taken: parsing the data, verifying that the invoice information has been parsed correctly, loading the invoice data into the database and calculating the primary and secondary user interface tables.

SINS processing, which may be an expanded version of SQL, may integrate shell script capabilities with interactive database utilities. SINS processing, which may be used throughout the loader process, performs several key functions. For example, it may be used whenever shell scripts hit the database for information of any sort. It may maintains a real-time status of invoice processing. SINS processing also may enable SQL to be run from a shell script with called arguments. It may echoe a SINS command to a GPP (Generic Pre-processor). This command may be expanded and allow a SQL call with an argument.

SINS may also be used to verify if an invoice exists in the database and may return an error if duplicate invoices are found. SINS processing may also include the driver for aggregating and formatting records from the primary tables to the user interface secondary tables. It may create unique identifiers in the secondary tables for the combined records from the primary tables. SINS processing may also be used to unload the database tables.

SINS Programming. SINS may be groups of SQL commands that are created as macros.

An example of a macro definition may be:

#define { MACRO_NAME(ARG1, ARG2, ARG3) } {
MACRO_BODY
}

Although the syntax may be different, the behavior may be similar to standard C pre-processing. For example, when MACRO_NAME (foo, bar, 2) is used, it is replaced globally with MACRO_BODY.

Also, SINS may support including files similar to C programs. An include example statement may be:

#include {utils.sql}

The include path may be searched for the file utils.sql in the include path (described below) and, if found, it may be included.

SINS files also have conditional inclusion, which is of the form:

#if {string1==string2}

STUFF

#endif

This tests to see if some value (string1) may be equal to some other value (string2). Typically, one of these strings may be a macro.

All SINS may be contained in the directory tree contained by, for example, $SALMON_HOME/conf/SINS. A shell script fragment, performSINS.sh, executes SINS. This script may not be executed by itself. Rather, it may be used by both the loader.sh script and confess.sh script, internally.

When SINS are run, there may be two parts: the loading of all the macros and the expanding of the macros that are called. If all only macros are defined, no output will result and no SQL that gets sent to the interpreter. When SINS are executed, the performSINS requires a main file and a SINS command. The main file may be a root file that includes all other files. These files all preferably exist in the SINS directory, at the top. Typically, the main files may be a list of “includes”, to pull in the appropriate files (and SINS) as needed. The loader.sh script may use loaderMain.sql, and confess.sh may use confessMain.sql. All files in the main file may be included as well as all subsequent files may be as well.

After all files that have been included have been processed, all possible macros have preferably been defined. At this time, the requested SINS commands may be performed, by expanding the requested macro. Preferably, two macros may always expanded, mINIT and mCLEANUP. Any other macros that get requested by loader.sh or confess.sh may be placed between these two macros.

By inspecting the confess.sh main file (confessMain.sql), an include for loaderMain.sql may be produced. Upon inspection of this file, an include for utils.sql may be produced. This file includes general utility macros to assist with compatibility issues if more then one database type is to be supported by the system. It also may promote easy readability of some SINS.

When SINS is executed, one or more items may be given to performSINS to configure the SINS appropriately. First, the type of database may be specified. Also, as much as is appropriate, the format, version, vendor, and type of file being processed may be specified.

Two things may be done with this information. First, an include path may be dynamically generated. Macros may also defined to be possibly tested for conditional inclusion (as described above). Below is a list of exemplary defines, and a list of directories (in order) that may be reviewed for include files. Anything beginning with “$” may be a variable that may be supplied by the program (loader.sh or confess.sh) that is performing.

Defines:

_DATABASE_—the type of database

_FORMAT_—the format of the data

_VERSION_—the version of the data being processed

_VENDOR_—the vendor of the data being processed

_TYPE_—the type of the data being processed

SINS Naming Convention. In general, the following naming conventions may be used: all macros begin with a lowercase m; all arguments begin with a lowercase a; preferably, SINS begin with the command that they are performing, if they are doing a single command (mINSERT_TableName, or mUPDATE_TableName); and files are named after the only (or main) SINS that are in the file (if the main SINS is called mINSERT_TableName, the file would be InsertTableName.sql).

Processing modules using SINS. There may be three options for processing the invoice data. First, a record set may be run in immediate batch mode; the default using the loader.sh script. Second, the records for the daemon may be queued, which allows for the records to be processed in the background (a scheduler triggers job processing). Third, scripts to execute each task individually (for example, parsing and verifying) may be run using arguments with the loader.sh script.

The loader.sh script automates the process of parsing, verifying, loading, and committing the invoice records (typically delivered on BDT) into the database. In a test environment, for example, invoices may be found on jigsaw-sun>BDT>*>* (for example, jigsaw>sun>BDT>Conversent>N>9106>V35. The N subdirectory represents billing data type, in this case, UNE files. The Q subdirectory (not shown here), represents Resale files. The 91* subdirectory indicates the region from which the data represents, for example, 9106 stands for, for example, Verizon New York, and V35 indicates the version of the invoice file.

Without any options, the script may parse, load, and SINS may process all files. The loader.sh script may include the following miscellaneous options set out below.

Before running the Loader.sh script, the following pre-requisites preferably are met. Bash may be installed as /bin/bash; Oracle may be installed correctly and sqlplus and sqlldr may be in the PATH; ORACLE_HOME may be properly set. Also, prior to executing this script, all database* properties found in Salmon.prop (in $SALMON_HOME/conf) are preferably edited so that the user name, password, and instance are set properly to point to the Oracle instance in which the tables and other database objects are created.

The program loader.sh is preferably run in $SALMON_HOME/bin/loader.sh, and the name of the file for loading may be provided. Output is parsed and intermediate files may be stored in $SALMON_HOME/output/*.

The program loader.sh in $SALMON_HOME/bin/loader.sh preferably is run and a name of the file to be loaded is preferably named. Output is then parsed and intermediate files may be stored in $SALMON_HOME/output/*. In addition, Log files are created in $SALMON_HOME/log/*. Below is a table summarizing example options for the loader.sh.

Loader.sh —<Argument><file name>

Loader.sh Script

| Options | Function |
|---|---|
| v | Turns on verbose logging. |
| p | Parses all specified invoice files but does not load the processed |
| | data into the database. |
| P | Sets a property. |
| I | Load the invoices from data that has been parsed. Invoice IDs |
| | are used to specify invoices. |
| s | Updates the secondary tables by running SINS. Invoice IDS |
| | are used to specify invoices. |
| j | Performs Java processing. |
| q | Queues all specified invoice files. |
| d | The script runs without exiting. It periodically looks for any |
| | queued invoices and processes them. |
| U | Unloads the specified invoice Ids. |
| b | Flags the invoice file as inbound (i) for cost or outbound (o) |
| | for revenue. |
| f | Forces the system to process an invoice file. With this |
| | argument, one can force the system to load the same |
| | BDT file twice. By default, the system does not allow |
| | loading the same file. |
| u | Processes usage files. Where appropriate use usage IDs or |
| | usage files. |

A typical example of an output from a successful run of the loader.sh is set out below:

===== PREPARING ALL REQUESTED FILES ==============
Calculating MD5 Sum... done
Source file.............. /home/data2/E/9104/v36/vbtcn02002.nva
File ID.................. 20
File MD5 Checksum........ 7203b41d6181246b9ddeee8b97bcc9a8
File identified as....... cabs (ver 36) from 9104 (E)
Preparation completed.... Successful
===== PROCESSING ALL REQUESTED FILES ==============
=============================
Source file.............. /home/data2/E/9104/v36/vbtcn02002.nva
File ID.................. 20
File MD5 Checksum........ 7203b41d6181246b9ddeee8b97bcc9a8
File identified as....... cabs (ver 36) from 9104 (E)
Running parser...........
.....
total records: 5549
total time: 10.0 seconds
average rate: 557 records/sec
Parsing finished........ No Errors detected
Loading all tables.......
.............................
Loading completed........ No Errors detected
SINS Processing..........
SINS.....................Committed
Finished processing...... /home/data2/E/9104/v36/vbtcn02002.nva (id 20)
Total Time Taken.........

The Loader.sh script may use identifyFile.sh to determine the format, version, and carrier of the invoice file. It may set the appropriate properties so later reading properties may yield a correct result.

Parsing the invoice. After loading the configuration file, the parser program may be run on the file. The parser may reads the specification files from the specified directory and may map files from the map files directory to determine how to read the invoice. In addition, the parser may determine what directory to output the file in.

Loading the Invoice. The loader program may then use the bulk loader program and associated control files to load data into the database. After the data is loaded, various SQL queries may be run if the -s option is given.

SINS Implementer Generic Hooks (SIGNs) may be used to allow an implementer to add behavior to the SINS processing without changing existing SINS. The file may contain a plurality of macros (prefixed with mSIGH_) that are empty. These macros may be called in various stages of the SINS processing and allow a user to add behavior to the process without changing existing SINS. To use a SIGN, the corresponding SIGNs.sql file may be copied to a new director based on the include path (described above), and/or when the SIGNs are activated. The desired macros may then be populated as needed.

For even greater flexibility, the SIGNs.sql file may be copied to a top area and then add includes to various files that may be created. The files may then be created in different levels to allow more general or more specific overrides. If the necessary SIGNs do not exist, a new hook may be added with the same method that existing hooks use.

SIGHs may also be used to add columns of new data to existing tables, to populate completely new tables (add a whole new insert SINS), or to override existing macros to change behavior drastically.

Unsupported invoices (i.e., invoices which do not have a corresponding configuration file), will yield an error when the system attempts to load and parse them. However, unsupported invoices may be parsed by an existing configurations for the parser by using a generic grammar.

Many of the grammars may be specific to a respective billing company. The invoice type may be identified by the OCN of the billing company, but many of the billing companies may have multiple OCNs. Therefore, a company-specific grammar may be used for a specific unsupported invoice. For example, Verizon Northeast has OCNs 9102 and 9104. If there is a grammar for the CABS version 35, 9102, then most likely that grammar also will work for CABS version 35 9104 because the bills are produced by the same company.

Parsing an invoice. The parser may be invoked from a command line or shell script using loader.sh (Loader.sh —<Argument><file name>). The options for the parser may be drafted in a standard —<opt><opt arg>manner. The parser may include a set of options that may be required and a set that may be optional as illustrated below.

Example REQUIRED OPTIONS

| | |
|---|---|
| b <bdt id> | BDT ID to assign to this file in the output. |
| f <bdt file> | BDT invoice file to be parsed. |
| G <grammar dir> | Directory where the grammar.y file is located. |
| L <lexer dir> | Directory where the lexer.def is located. |
| l <lookup dir> | Directory where the lookup files are located. |
| m <mappings dir> | Directory where the .map files are located. |

-o<directory path> Directory to which output files are to be written. User invoking the parser must have write permission for the directory.

-s<reader spec dir> Directory where the .spec files are located for this particular version of BDT.

-v<version number> Version number of the BDT being parsed.

Example OPTIONAL OPTIONS

-c<checksum> Use the checksum specified. Do not calculate the checksum of the input file. Cannot be used with -e.

-d Generate debugging sequences in the output files.

-e Simply calculate the checksum of the input file and exit. No other options except -f are required when using -e. Cannot be used with -c.

-E<exceptionsfile> Specify the file to be used for logging exceptions.

-p<outputformat> Specifies the format of the output files. Also changes the suffixes of the output files. The current allowable values are:

| | |
|---|---|
| Loader | The default \| delimited format. (.dat) |
| CSV | Comma separated. (.csv) |
| HTML | HTML tables. (.html) |

-n Verify that the BDT is valid grammatically, don't produce output files.

-r Enable unused element parsing. Normally the parser will not parse record fields that will never be outputted. This enables parsing these elements.

-t Verify that the BDT can be read. Do not check it grammatically. Do not produce output.

-V<log level>Specify the log level and log mask to use for logging. The format of <log level>is the following:

<INFO|LOW|MEDIUM|HIGH|FATAL>[:<hex number>]]

A .spec file may specify the format of an individual BDT record type. Preferably, there may exist one spec file for every record type, and a set of spec files for every type and version of the BDT that is to be parsed. The file may include the record type id, the record type name, and a list of the name, offset, length and format of all the fields in a record of that type. The parser may use these files for reading and interpreting the raw BDT record data. The format for a spec file is as follows:

```
.spec file BNF:
Spec_File := Record_Name
Record_Type_ID
Field_Spec*
Record_Name := <string>
Record_Type_ID := <8-digit integer>
Field_Spec := Field_Name
    Start_Byte
    End_Byte
    Field_Type
Field_Name := name:<string>
Start_Byte := start-byte:<integer>
End_Byte := end-byte:<integer>
Field_Type := type:<format>
```

.Spec file field descriptions:

| Field | |
|---|---|
| Name | Description |
| Record | An 8-digit integer identifying the record type. In the CABS case |
| Type | it is made up of the 6-digit CABS record id and the 2-digit |
| ID | CABS record id suffix. |
| Record | A string identifying the record terminated by a newline. |
| Name | Required but not currently used. In the CABS case it |
| | is the name from the CABS specification which is |
| | usually non-descriptive at best and just plain |
| | confusing at worst. |
| Field | The field specs tell where in the physical BDT record line the |
| Spec | field is (Start_Byte, End_Byte), what the field's name |
| | is (Field_Name), and what type of data it contains |
| | (Field_Type). |
| Field | A name for the field. The name is taken to be every character |
| Name | (including white space) after the colon until the new line. |
| Start | A 1-based index (i.e. the first byte in a record is byte 1) into the |
| Byte | record where the particular field starts. |
| End | A 1-based index into the record where the particular field ends |
| Byte | (the field data includes the byte at the End_Byte position). |
| Field | Specifies what type of data the field includes. The format string |
| Type | is comprised of a combination of the following specifiers. |

Valid specifiers may be:

```
X(<length>) Sequence of characters from the printable ASCII set
of specified length.
9(<length>) Sequence of numbers of specified length.
S Sign +/−.
V Decimal point.
    Examples:
      X(100) String of length 100.
```

S9(9)V9(2) Signed floating point number with 9 numbers before the decimal and two after. 9(4) Four digit unsigned integer.

Format strings for date and times:

X(6) (CCYYMM) Date with the century, year, and month.

X(8) (CCYYMMDD) Date with the century, year, month, and day.

9(4) (HHMM) Time with hour and minute.

Accordingly, below is an example partial spec file for the 10-60-90-00 CABS record type:

DETAIL OF CIRCUIT LISTING TOTAL 10609000

name:RECORD IDENTIFICATION

start-byte: 1

end-byte:6

type:X(6)

name:RECORD IDENTIFICATION SUFFIX

start-byte:7

end-byte:8

type:9(2)

name:SUFFIX RECORD IND

start-byte:9

end-byte:9

type:9(1)

name:ACCESS CUSTOMER NAME ABBREVIATION

start-byte: 10

end-byte: 14

type:X(5)

name:BILL DATE

start-byte: 15

end-byte:22

type:X(8) (CCYYMMDD)

name:BILLING NUMBER

start-byte:23

end-byte:32

type:X(10)

name:CUSTOMER CODE

start-byte:33

end-byte:35

type:X(3)

name:PACK SEQUENCE NUMBER

start-byte:36

end-byte:39

type:9(4)

name:RECORD SEQUENCE NUMBER

start-byte:40

end-byte:48

type:9(9)

name:RESERVED FOR EC USE

start-byte:49

end-byte:61

type:X(13)

name:TOTAL INTERSTATE CIRCUIT CHARGES

start-byte:62

end-byte:72

type:S9(9)V9(2)

Map Files. A map may specify which record fields from which BDT records are used to populate a particular database table. There may exist one map file for every table to be populated and there may exist a set of .map files for every type and version of BDT to be parsed. These files may not instruct the parser that a table should be populated with all occurrences of a particular BDT record, the files may merely specify what table members may be populated from which record fields (if the table is to be populated by a record).

The file name of the map file may specify which table for which it is a map. Therefore, the mappings for the C_UNEOCCItem table is in the C_UNEOCCItem.map file (for example).

.map File BNF:

Map_File:=Mapping*

Mapping:=<table member name>:Source

Source:=Record_Field | Foreign_Key | Primary_Key

Record_Field:=<record type id>:<recordfield name>

Foreign_Key:=<foreign_table name>.<foreign_table field>

Primary_Key:=Generated

Map file definitions:

Mapping: Specifies the table member name and from what source it should be populated.

Source: Source from which to populate a table member can either be a field from a BDT record, a foreign key to another table, or an auto generated primary key.

Record Field: Specifies which record type and which field from it to get data from. The <record type id> must be one of the 8-digit IDs from the spec files. The <record field name> must exactly match (including white space) a field name from the spec file of the record type.

Foreign Key: Specifies to populate the table member with the data in member <foreign_table_field> from foreign table <foreign_table_name>.

Primary Key: Specifies to auto generate this data from the primary key of the primary table.

Map file example:

BDTID:BDTInfo.BDTID

PackID:C_CSRPack.PackID

C_UNECircuitLocationContID: Generated

C_UNECircuitLocationID: C_UNECircuitLocation.C_UNECircuitLocationID

RecordSequenceNumber:40151500:RECORD SEQUENCE NUMBER

UsocOrFid:40151500:USOC OR FID

FidData:40151500:FID DATA

FidDataContinuationlnd:40151500:FID DATA CONTINUATION IND

Lexer files. The lexer.def file may be input to the parser and may define the mapping between records and grammar tokens. Because some records may be disambiguated beyond record type id, the lexer.def file may include a script that analyzes the contents of a record and determines the appropriate token number to return. The script may be run once for each record that is parsed.

Like the grammar, the lexer.def file may be generated for each BDT to be parsed depending on the format of the BDT, version, and OCN. The file may be generated by preprocessing the following files from the conf/lexer directory: lexerMain, lexer.def, casedefs.def, and cases.def. The loader.sh script may be responsible for running the preprocessor at runtime, but one may also run the genlexer.sh script to generate the grammar for debugging purposes.

On each run, the preprocessor may be given a set of include paths that depend on the type, version, and originating OCN of the BDT the grammar is for. The include paths in the order that they, for example, are searched are as follows:

<conf dir>/lexer/<bdt format>/<org. OCN>/<file version>

<conf dir>/lexer/<bdt format>/<org. OCN>

<conf dir>/lexer/<bdt format>/<file version>

<conf dir>/lexer/<bdt format>

<conf dir>/lexer/include

<conf dir>/lexer

This may allow the grammar to be changed for a specific BDT type simply by creating a file higher up in the include path. For example the lexerMain file, which is the only input file that is fed to the preprocessor, is simply:

#include {lexer.def}

The preprocessor then may search the include paths for the file lexer.def to include. In general, the only lexer.def files that may be found are in the <conf dir>/lexer/<bdt format>directory. This enables AEBS, CABS, etc. to be supported using the same preprocessor. If necessary, the whole grammar for a particular format/version/OCN may be overrided by, for example, simply placing a lexer.def file into <conf dir>/grammar/<bdt format>/<org. OCN>/<file version>.

Grammar files. The grammar files may define a context-free grammar for interpreting BDT files. The BDT (CABS, SECAB and AEBS) files have a grammatical structure. The records are the words, and groupings of the words are the sentences. Because the CABS and AEBS specifications state that certain record types must follow others, a grammar may be expressed English (though less complicated). The grammar files may express this grammar, and also may specify what to do when a grammatical element is complete. For example, the 10-50-* CABS records describe the taxes on a bill. To describe the taxes, there may be a series of 10-50-05-00 (Tax Detail Records) that describe the individual tax charges, and after all the 10-50-05-00s there must follow a 10-50-90-00 (Tax Total) record.

The actual grammar input into the parser may be generated for every BDT file by a preprocessor step. The output of this step specifies a grammar in a YACC compatible format. The loader.sh script may be responsible for running the preprocessor at runtime, but one also can run the gengrammar.sh script to generate the grammar for debugging purposes. As mentioned previously, the grammar output may be BISON- and YACC-compatible. Therefore, either one may be used for debugging the grammars.

CDR Adapters and Processors. CDR Adapters and Processors may be used to convert and process raw Call Record Data (CDR). The conversion process may enable the Revenue Assurance system according to the present invention to examine line-level usage and to compare measured, billed, or reported usage against each other.

Measured usage may represent data from the equipment of customers, such as switches. Billed or invoiced usage may refer to usage as reported from the client billing system. A third data source may be reported usage, which may be reported by third-party carriers, such as the Interexchange carriers.

Line-level usage validation is functionality that may categorize, summarize, and/or compares usage from two sources for a billing period by individual telephone numbers. The comparison produces discrepancies, indexed by Working Telephone Number (WTN), billing period, and other key fields, which are reported in Peg Count and MOU differences.

Analyzed data may be client-specific. The system according to the present invention may handle, at a minimum the following data sources: measured usage, billed or invoiced usage, and reported usage. Measured usage, which comes from CDRs from the client switch or switches, may include toll, calling card, local, and directory assistance information (other types of information may also be included as necessary to meet a client's needs). Data formats may include, for example, AMA, EBAF, or SS7 CDR (not SS7 messages). Additional data formats may be added as necessary to support client needs.

Invoiced usage, which may be extracted from the client billing systems, may be available in numerous proprietary formats.

Reported usage may be from a third-party carrier such as an IXC, and may be generally in the form of a Daily Usage File (DUF), which may come in various data formats.

Line-level usage may be analyzed by systemically comparing usage data from one source against usage data from another source. Accordingly, by comparing the usage information from the two sources, the system may report discrepancies.

CDR Adapter. A CDR Adapter implements specific methods of CdrReader and may be responsible for taking in raw data and creating CallDetail objects that may be passed along to the CDR Processors. Supporting data and options required by a given CDR Processor are provided either via the CdrGlobals objects or from the Properties object. Each adapter may include a unique identifier associated with it, for example, AMA.

A CDR Processor may be responsible for taking in the CallDetail objects created by adapters and processing them in a manner appropriate for the processor. Supporting data and options needed by a given CDR Processor may be provided in one of the following ways: an array of string options (specified in a file with the given processor), via the CdrGlobals objects, an OutputFilenameSpec object (which controls the name of the output file for the processor), and from a second array of string options (specified along with the current input file which is generally used by the OutputFilenameSpec object), for example. Each Processor may have a unique identifier associated with it (for example, CdrProc_WtnOrigBillStats).

The output of a CDR Processor may include the WTN and pairs of Peg Count/MOU columns. For example:

WTN:string|IntralataPC:int|IntralataMOU:number|InterLataPC:int|InterLataMOU:number|InterStatePC:int|Inter StateMOU:number|Internatio

nalPC:int|InternationalMOU:number|TollFreePC:int|TollFreeMOU:number|OtherPC:int|OtherMOU:number|To llCallPC:int|TollCallMOU:number

5086538640|28|80.700000|0|0.000000|0|0.000000|0|0.000000|0|0.000000|0|0.000000|0|0.000000

5088796100|1|6.900000|0|0.000000|0|0.000000|0|0.0000001010.0000001 1 10.0000001010.000000

6172271286|1|19.000000|0|0.000000|0|0.000000|0|0.000000|0|0.000000|0|0.000000|0|0.000000

6172328814|2|16.700000|0|0.0000001010.000000|0|0.000000|0|0.000000|0|0.000000|0|0.000000

6172364480|1|0.400000|0|0.000000|0|0.000000|0|0.000000|0|0.000000|0|0.000000|0|0.000000

Using scripts to process and store processed data. The GencricLineLevel program may process a CDR. This program may take the following arguments:

GenericLineLevel Program

| Argument | Description |
|---|---|
| p | Processor list file name (required) |
| r | CDR reader name (required) |
| i | Input file list file name (required if -f not |
| | used) |
| n | Base ID |
| c | Properties file |
| s | File Separator |
| f | Input file information (required if -i not |
| | used) |
| P | Property Information |
| V | Enables verbose logging |

The -p and -r arguments may always used, and either -i or -f may be provided. The file separator defaults to the “|” if not specified and the Base ID defaults to 1. The -V argument enables verbose logging. The -f argument may be equivalent to providing one line from the input file list on the command line. The Properties file defaults to Properties.txt.

The CDR reader name may be a unique identifier associated with a CDR Adapter. Each line in the Processor list file may include the following: CDR Processor unique identifier, followed by a string used to create an OutputFilenameSpec object, followed by any other processor-specific information (such as location of reference data). The information may be separated by the separator specified via the -s option. An example of a line in a Processor list file is as follows:

CdrProc_WtnOrigAlgxStats|./results.test/{2}_WtnOrigAlgx_{%}_{#}.txt

The meaning of the string used to create the OutputFilenameSpec object may be as follows: {%} is replaced by the date of the call as provided by the CallDetail object; {#} is replaced by the File ID number, which is calculated by adding the offset of the input file in the input file list and adding the Base ID to it; {1}, etc., is replaced by the equivalent field provided in the input file list; and any other text is passed through untouched.

Unlike the lines in the Processor list file, the lines in the input file list file may include the same number of options. Accordingly, each line may include the following: input file name, followed by the date associated with the file (when it was created or received), followed by CDR format, and finally any other options. The information also may be separated by the separator specified via the -s option. An example of options in the input file list file:

/u04/CDR/ama/bos_{—}20020401_{—}165107-165246.ama|20020401|AMA

/u04/CDR/ama/bos_{—}20020401_{—}165247-165358.ama|20020401|AMA

After combining the information in the two examples above, examples of output files may be as follows:

./results.test/AMA_WtnOrigAlgx_{—}20020331_{—}1.txt or

./results.test/AMA_WtnOrigAlgx_{—}20020401_{—}1.txt.

Generally, most of the work involved in scripting the processing may include two items: tracking which CDR or DUFs have been processed and constructing appropriate input file list files. The remainder of the work has been done for the customer in the LineLevel Perl module.

A typical Perl script to handle this process is illustrated below (the script is generally more complex and may have a completely different structure).

```
#!/usr/local/bin/perl
use Properties(“$0”, “../../../”);
use lib “$Properties::SalmonHome/lib/perl”;
use LineLevel;
sub ExecuteLineLevel
{
  my($input_file) = shift;
  my($id) = shift;
  \grave{ }$LineLevel::LINE_LEVEL -p prop.txt -r Ama -i $input_file -n $id;
}
sub MakeInput
{
  my($input_file) = shift;
  my($dir) = “/u04/CDR/ama/”;
  opendir(DIR,$dir);
  my(@temp) = readdir(DIR);
  closedir(DIR);
  my($file);
  foreach $file (@temp)
  {
    next if ($file !˜/\.ama/);
    push(@files,“$dir$file”);
  }
  my($date);
  @files = sort(@files);
  my($count) = 0;
  my(%map);
  $dir = qq {$dir};
  open(FILE,“>$input_file”) || die “Can't open $input_file
  for writing: $!\n”;
  foreach $file (@files)
  {
    $file =˜/\$dir[a-zA-z]+_(\d+)_/ && ($date = $1);
    $count++;
    $map {$count} = $date;
    print FILE “$file|$date|AMA\n”;
    last if ($count > 4);
  }
  close(FILE);
  return \%map;
}
sub CombineFiles
{
  my($map) = shift;
  my($dir) = “./results.test”;
  opendir(DIR,$dir);
  my(@temp) = readdir(DIR);
  closedir(DIR);
  my($file);
  my(@files);
  foreach $file (@temp)
  {
    next if ($file !˜/\hat{ }AMA.*\.txt$/);
    next if ($file =˜/_\d\d\d\d\d\d\d\d\.txt/);
    push(@files,“$dir/$file”);
  }
  my(@final) = LineLevel::CreateIntermediateFile($map,@files);
  my(@data);
  foreach $file (@final)
  {
    @data = LineLevel::ConvertFileNameToStorageData($file);
    LineLevel::StoreFile($data[3],$data[2],$data[0],$data[1],
    $file, “./library.text”);
  }
}
$map = MakeInput(“input.txt”);
ExecuteLineLevel(“input.txt”, 1);
CombineFiles($map);
```

As the example demonstrates, the first few lines may be common to all LineLevel-related scripts, although the location of the Perl executable may vary. The MakeInput portion may need to move files around to signify pre- and post-processed states or it may need to keep an index of files that have already been processed.

As will be appreciated by one of ordinary skill in the art, the ExecuteLineLevel portion of this script, may be fairly standard. The $LineLevel::LINE_LEVEL may be executed with appropriate options.

The final step (CombineFiles), may vary similarly to MakeInput. The LineLevel::methods may generally be called, but the filtering of the files to be processed may be non-standard. LineLevel::CreateIntermediateFile will take a hash of input file dates and maps the order as passed to GenericLineLevel to a date, as well as an array of processed file names in the form of AMA_WtnRemAlgx_{—}20020501_{—}1.txt.

This method converts the files to the src_type_calldate_filedate.txt format and merge all relevant files that would map to the same output (for example, AMA_WtnRemAlgx_{—}20020501_{—}20020501.txt). This may be accomplished by looking up the 1 in the hash of input file dates. This assumes that the source file may be from src_type_calldate_filedate_#.txt (for example AMA_WtnRemAlgx_{—}20020501_{—}1.txt).

At the end of process, the files may be stored in the library which may be associated with a directory (in the above example, ./library.text). Each file may be stored and retrieved by the following key fields: File Date, Call Date, Source, and Comparison Type. During retrieval, the date may be specified as follows: a date string is of the form dateBlock1, dateBlock2, and the like. A date block may be either a date or a date range. A date range may be of the form startDate-endDate where the year portions are the same. A date may be of the form 20020506 (YYYYMMDD).

The following discusses scripting the retrieval and the merging of two homogenous sets of data (from different sources) from the “library,” comparing these sets of data, and generating discrepancies. This part of the process may be very similar to scripting the processing of CDRs because both may be done in Perl, for example, and both may use some of the same functions.

Accordingly, a typical Perl script to handle this process may look as follows (although it will be more complex and could have a completely different structure):

```
#!/usr/local/bin/perl
use Properties(“$0”, “../../../”);
use lib “$Properties::SalmonHome/lib/perl”;
use LineLevel;
sub MakeComparisonSet
{
  my($calldate) = shift;
  my($filedate) = shift;
  my($output) = shift;
  my(@files) =
LineLevel::GetFiles($filedate,$calldate,“AMA”, “WtnOrigAlgx”,
“./library.text”);
  my($filter) = sub { return LineLevel::BlankFilter(@_); };
  LineLevel::MergeFiles(1,$output,“${output}_temp”, $filter, @files);
}
MakeComparisonSet(“20020401”,“20020401”,“Ama1.txt”);
MakeComparisonSet(“20020401,20020331”,“20020401,20020331”,
“Ama2.txt”);
$excludes = \%empty;
$data[1] = LineLevel::parseFile(“Ama1.txt”,$excludes);
$data[2] = LineLevel::parseFile(“Ama2.txt”,$excludes);
my($ofile) = “Ama_out”;
my($ofile1) = “${ofile}_1.dat”;
my($ofile2) = “${ofile}_2.dat”;
my($oboth) = “${ofile}_both.dat”;
for $i (1..7)
{
  push(@cols, $i);
}
LineLevel::makeDiffs($ofile1,$ofile2,$oboth,773,0.0,“20020401”,
“BOS”,$data[1],
$data[2],\@cols );
‘cat $ofile1 $ofile2 $oboth > UI_USAGEDISCREPANCY.dat’;
‘rm $ofile1 $ofile2 $oboth’;
LineLevel::LoadDiscrepancies(“./”);
```

In this process, the first part of the script may remain the same, in that the routine retrieves the relevant files based on the two date keys, source type and data type. Those files may then be merged into one file, which may then load into memory via LineLevel::parseFile, and three different discrepancy files may then be created via LineLevel::makeDiffs. The three files may be WTN entry in Source 1, but not in Source 2, in Source 2, but not in Source 1, and in Source 1 and Source 2, but may be with different values for PegCount and MOU. Finally, the three files may be combined into one and loaded into the database via LineLevel::LoadDiscrepancies.

Generally, two different sources may be compared; for example, AMA and SS7, instead of two sets from the same source as previously mentioned. In addition, when running the makeDiffs, the 773, 0.0, 20020401 and BOS arguments may be specified more dynamically as determined by the appropriate business logic.

The retrieval (through the MakeComparisonSet) and the discrepancy generation portion may be separated into separate scripts. Additionally, a non-blank filter may often replace the blank filter portion.

Generating Discrepancy Information. The Discrepancy Type may identify the two data sources being compared and the type of comparison being done. The first 8 bits may be used for the two data sources and the second 8 bits as the type. The Bucket Type may be relative to the Discrepancy type and may be generally just an enumeration of the categories within that Discrepancy type (for example, IntraLATA, Toll Free, etc.). A discrepancy consists of the following information (for example): WTN, Bill Period Date, Zone, Discrepancy Type, Bucket Type, PegCount1, MOU1, PegCount2, and MOU2.

For example:

5083100078|20020701|BOS|259|2|13|41.400000|16|56.900000

5083100078|20020701|BOS|259|3|184|537.500000|178|519.00000

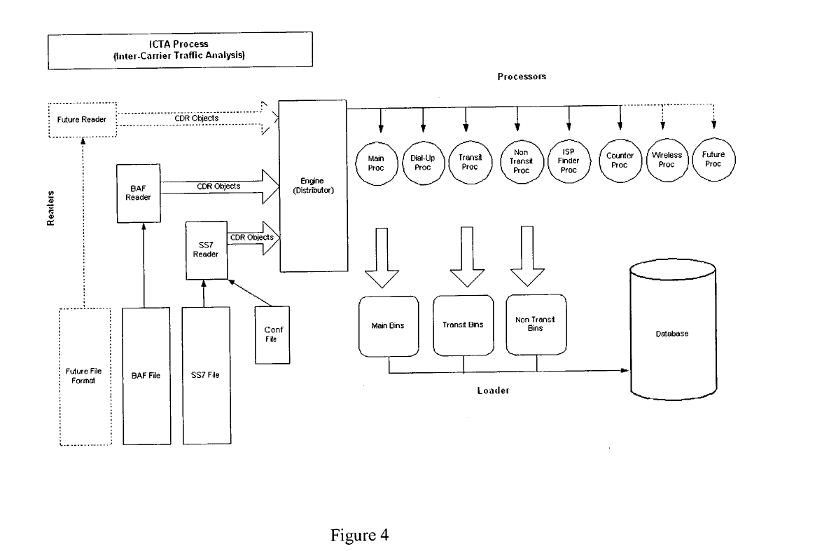

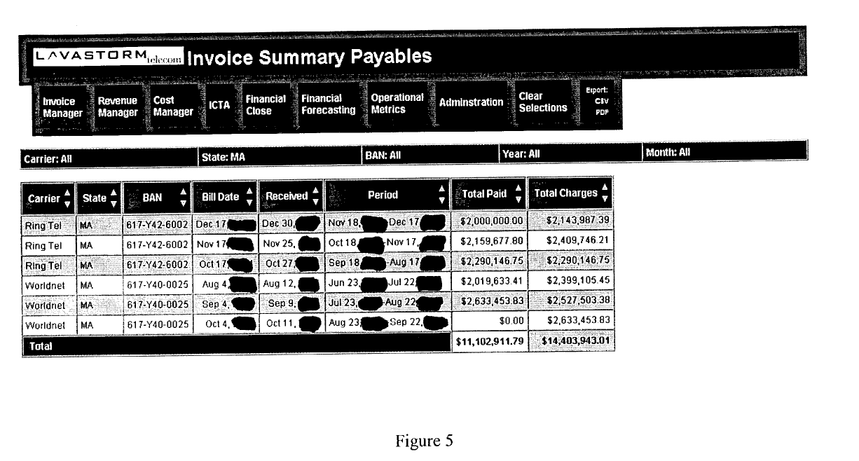

Inter-carrier traffic analysis (ICTA) processors (FIG. 4). The Revenue Assurance system according to the present invention may use ICTA Processors or banners to help compare the measured (MOU) data versus the data represented in an invoice. This may be referred to as Measured versus Invoiced. This comparison data may be used to show charge discrepancies.

The invoice data may be logically grouped. The data in the bins are sectionalized based on the direction of the traffic (inbound/outbound) and the jurisdiction (for example, local traffic) as reported in the invoices. The system uses SINS to parcel the data into the appropriate ITCA bins. For example, if the invoiced MOU represent totals for transit traffic, three bins may be used: interstate, intrastate, and local. The measured MOU for transit traffic may be binned the same exact way: interstate, intrastate, and local. The system may compare data in the corresponding bins, for example, invoiced transit interstate MOU versus measured transit interstate MOU and so on. Using comparison data, the system may create charge discrepancies. For outgoing invoices, no disputes or discrepancies may be created.

All ICTA processing may be done before the invoice is loaded into the database. The ICTA processors may use OCNs to identify the carrier using the LERG. On invoices, the Access Customer Name Abbreviation, which is not in the LERG, may identify the access customer of the invoiced usage. The administrator must provide the carrier code for the customer for outgoing invoices. This is done in the UI_BAN table.

Flexibility may be built into the system using the properties file. For example, the system may be instructed to ignore discrepancies if the financial impact is less than $ 1,000. The system may use two properties, which may be used in MOU Measured versus Invoiced functionality. These properties are in Salmon.prop. They may be set to these default values:

Discrepancy.MOUDifferenceRatio=“0.05”

Discrepancy.EstimatedFinanciallmpact=1000

A MOU-type discrepancy may be generated if the absolute value of the ratio between the MOU difference and the invoiced MOU is larger than the first property and if the Estimated Financial Impact of the MOU difference is larger than the second property.

The system also may also modify SINS to accommodate specific agreements between carriers. A SINS file may be created specifically for the carrier to reflect an uncommon agreement. For example, there could be a maximum limit on the MOU that a carrier can bill. This may be reflected when the invoice and measured data are compared. Therefore, a field called Correct Billed MOU may be created. This field reflects all the business agreements the carrier may have and it also may consider if there were any minutes billed already in previous invoices for a specific time period.

All processors may derive from the abstract class CdrProcessor:

```
namespace Salmon
{
class CdrProcessor
{
public:
  virtual void process(const CallDetail* pCdr) = 0;
  virtual void onBegin( ) {}
  virtual void onEnd( ) {}
  struct Stats
  {
    int m_nCount;
    double m_fMou;
    Stats( )
    {
      m_nCount = 0;
      m_fMou = 0.0;
    }
    virtual ˜Stats( ) {}
    void update(const CallDetail* pCdr)
    {
      m_nCount++;
      m_fMou += (pCdr->getHoldSeconds( ) / 60.0);
    }
    void update(const Stats* pStats)
    {
      m_nCount += pStats->m_nCount;
      m_fMou += pStats->m_fMou;
    }
  };
};
} // namespace Salmon
```

All CdrProcessor-derived classes may implement the process( ) method, which may be called by the ICTA engine for each Call Detail Record (CDR) in the file. The CallDetail interface may be detailed and may be found in the file CallDetail.h. Most CdrProcessor-derived classes may take a pointer to an IctaMainBins and/or an IctaTransitBins object in which running totals may be stored:

```
namespace Salmon
{
class IctaMainBins
{
public:
  CdrProcessor::Stats* getStats(int nActualDate,
    int nPeriodDate,
    const char* szCarrier,
    const char* szState,
    int nLata,
    int nBin,
    int nLabel);
  ...
};
class IctaTransitBins
{
public:
  CdrProcessor::Stats* getStats(int nActualDate,
    int nPeriodDate,
    const char* szCarrier,
    const char* szState,
    int nLata,
    const char* szCarrier2,
    int nBin);
  ...
};
} // namespace Salmon
```

The dates may be passed as integers in YYYYMMDD format. The PeriodDate may be the date of the end of the billing period, which may be obtained from a BillCycleMap object (declared in BillCycle.h), which may often passed as a construction parameter to the CdrProcessor-derived class. The Bin and Label parameters are numeric identifiers for the stat type. An initial listing of these values can be found in BinList.h, but implementers may add new (non-conflicting) values as needed.

Processors are instantiated and installed in the main( ) function in main.cpp:

//instantiate main objects

IctaMainBins oMainBins;

IctaTransitBins oTransitBins;

BillCycleMap oBillCycles(BILL_CYCLE_MAP_FILE);

CdrProcEngine oEngine;

//instantiate processors

CdrDotCounter oCounter(4000, 25);

MyNewProcessor oMyNewProc(&oMainBins, &oBillCycles);

//install processors

oEngine.addProcessor(&oCounter);

oEngine.addProcessor(&oMyNewProc);

Post-Load Java processing may be performed. After an invoice or CDR file is loaded, Java classes are called to perform post-load processing. Rate and quantity validation may be performed using post load Java processing. Rate validation is performed on both recurring and usage charges. The design of rate validation allows for extension due to the expected difference in rate application, especially for recurring charges. Quantity validation is less complex than rate validation and is not directly extensible.

For recurring charges the Validator_Subtype may correspond to the charge type in the recurring charges details. When processing invoices, all charges of charge type “Unit” and “Mileage” may be validated by the class RateValidatorRecurringBasic. This same validator may be capable of handling both charge types. Another charge type of “Not Applicable” is a charge type found on some line items. The validator for these types of charges is RateValidatorRecurringUnassigned.

RateValidatorRecurringBasic may compare all charges against the rate book in order to create discrepancies where appropriate.

RateValidatorRecurringUnassigned may catch charge types that are not validated. It may generate discrepancies to indicate that there is no rate book entry. However, during discrepancy handling a rate book entry may be created for this entry to prevent another discrepancy from being generated.

The following explains how the class RateValidatorRecurringBasic performs validation.

An in memory rate book of the Unit and Mileage recurring entries are created from the rate book. This data may be stored in a hash map with the keys OCN/State/Jurisdiction/USOC/Charge Type.

Each line item of the invoice may be processed for recurring unit and mileage charges. Discrepancies are created as they are determined and exceed the individual charge threshold. Discrepancies are keyed differently than the rate book. In addition to the rate keys of OCN/State/Jurisdiction/USOC/Charge Type, Unit Rate/Mileage Rate/Undercharge are further keys for the discrepancy hash table.

Discrepancies may be reported for “No Rate Element Found” types. However, undercharges and overcharges may only be reported if the aggregate charge threshold is exceeded.

The RateValidatorRecurringBasic uses a class DbRecurringlnterface may access the invoice line items. This class is created to isolate changes if there were any changes to the UI tables.

To report discrepancies, the DbDiscrepancy class may be used. Without modification this class may be used to create discrepancies. To generate a discrepancy, the following steps are performed:

### Create a DbDiscrepancy Object

For each discrepancy call the set description method to initialize the discrepancy. The text parameter preferably includes the description of the discrepancy.

Then call SetNameValue for each name value pair of additional information desired to be set with the discrepancy UI. If there are hidden name value pairs that are being set for internal use but not for display set the hidden parameter to true. Call InsertDiscrepancy to insert the discrepancy record into the database.

Database schemes. The revenue assurance system according to the present system includes the following tables: primary, secondary, UI, reference, info, and sequence.

The loader uses inserts data into the primary tables. SINS processes use the primary table data to populate secondary tables. The UI tables hold information that supports the user interface (UI). The reference tables, which are populated at installation, provide lookup information. The info tables are used for auditing, logging information about loaded data. The sequence tables are created to ensure ID uniqueness.

After incoming data is parsed, it is loaded into primary tables. A new set of primary tables must be created for every type of incoming data. Exemplary sets of primary tables for the present invention include: CABS tables, manual entry tables, and ICTA tables, SECAB, AEBS, and EDI 811 tables.

The schema generator automatically generates CABS tables. The schema generator uses the spec files, and a table definition configuration file to generate version-specific ddl files. The table definition configuration file (cabstables.dat) is created using domain knowledge of CABS systems and CABS invoice files (BDT). The version-specific ddl files go through minor manual modifications to generate a version independent schema.

CABS tables are named using the prefix “C_” for example. Often the same record type can land in multiple tables depending on the circumstances. The parser disambiguates these records depending on individual elements or position in the invoice data file.

Manual entry tables support the MS Access template for entering invoices manually. This is for invoices that are not in machine-readable format. The manual entry tables are named using the “M_” prefix and have the following hierarchy:

```
<M_ACCOUNT INFO>
  <M_ADJUSTMENT>
  <M_MRC>
    <M_MRCUSOC>
  <M_OCC>
    <M_OCCPHRASE>
      <M_OCCPHRASEUSOC>
  <M_TAXES>
  <M_USAGE>
    <M_USAGE_DETAIL>
    <M_USAGE_STATS>
```

ICTA tables are where binned CDR data ends up. For example, UI_ICTAMAIN—holds main Intercarrier Traffic Analysis rolled up data and UI_ICTATRANSIT—holds transit Inter-carrier Traffic Analysis rolled up data (two carriers, pier and other end).

Secondary tables. After data are loaded into the primary tables, additional processing is done to create data that can be accessed by the UI server without any real-time processing. This secondary data, which is generated by SINS, includes mostly rollups and summaries. There are three types of secondary tables—temporary tables, Network Element Discrepancy (NED) tables, and invoice viewer tables.

Temporary tables are created during SINS processing generally to simplify and accelerate generation of other secondary tables (NED, invoice viewer, etc.). The data in the temporary tables are deleted after a successful completion of a load.

Network Element Discrepancy Tables. The NED tables support the RBOC NED functionality, which identifies discrepancies between the network inventory and the invoices. The three NED tables are as follows:

N_RRNEDDEDUCEDINVENTORY—This table is updated by SINS when outgoing CABS bills are loaded. The system examines Monthly Recurring Charges and OCCs, updating dates of new circuits being established or disconnected.

N_RRNEDMISSINGINNICIRCUITS—This table, which is populated by the NED process, contains circuits that are being billed but are not represented in the network inventory.

N_RRNEDUNBILLEDCIRCUITS—This table, which is populated by the NED process, contains circuits that are in the network inventory but are not being billed.

The invoice viewer tables are created to support the viewing of invoices in a user interface. These tables are created by SINS processes, which select the most important data from the primary tables and summarize it. These tables combine all different types of invoice related primary tables (CABS, manual, AEBS, . . . ).

User Interface tables are support the administration of the user interface.

Cost Discrepancy Table. Invoice validators produce invoice cost discrepancies. These are functional modules that examine an invoice and generate discrepancies.

The table that stores discrepancies is as follows:

TABLE
UI_DISCREPANCY

| Field | Type | Description |
|---|---|---|
| UI_DISCREPANCYID | NUMBER | This is unique number needed for UI |
| | | manipulations. It is automatically |
| | | assigned when a row is created by a |
| | | stored procedure. |
| VALIDATOR_TYPE | VARCHAR2(10) | Records the type of the type of |
| | | discrepancy. Values should be |
| | | distinct for each validator and |
| | | permanently associated with that type |
| | | of validator. |
| VALIDATOR_SUBTYPE | VARCHAR2(50) | Records the sub-type of the |
| | | discrepancy. This is context specific |
| | | to a validator. For example, a |
| | | recurring charge rate validator might |
| | | indicate whether this is a mileage or |
| | | unit rate discrepancy. |
| BILLID | VARCHAR2(50) | This is the invoice (bill) identifier |
| | | associated with a value in |
| | | UI_BILLSUMMARY.BILLID. |
| DESCRIPTION | VARCHAR2(1024) | Structured text that describes the |
| | | discrepancy or carries hidden |
| | | information about the discrepancy |
| | | that is needed for further processing. |
| | | See discussion below on how this is |
| | | formatted. |
| STATUS | VARCHAR2(16) | Records the status of the discrepancy |
| | | according to how the user (ICA) has |
| | | decided to handle the discrepancy. |
| | | The initial value is Open - other |
| | | values include Dismissed, Disputed, |
| | | Updated, etc. |

The description field carries multiple sub-texts. A vertical bar (|) with optional white space around is used to delimitate each sub-text. Each sub-text is preferably one of three types:

Plain text—a sub-text that is to be simply displayed to the user or copied directly into a dispute letter. These are identified by the first character being ‘*’.

Visible Name/Value Pair—a sub-text consisting of a name and a value, separated by ‘=’. These will be shown to the user as such. Further, certain well-known pieces of information may be located and copied into programmed fields in a dispute or fed back into reference books. These are identified by the first character, which is ‘+’.

Hidden Name/Value Pair—a sub-text consisting of a name and a value, separated by ‘=’. These are identified by the first character being ‘−’. Typically these pairs carry fielded information, which may be necessary in processing the dispute in special ways—for example, to update a rate book entry with the discovered information.

A number of other tables handle invoices and disputes, for example:

Table UI_BillWorkflow. This table keeps track of all the invoices, including their current states and the associated owners.

Table UI_BillWorkflowHistory. This table maintains the history of the invoice, with data on the current state and past states from receipt through closure. Data includes where the invoice went, who changed the state, etc. Each time the state of the invoice changes a new record is added.

Table UI_Dispute. This table contains all of the disputes as well as information that includes who owns them, their states, any related notes, and the discrepancies from which the disputes were created.

Table UI_DisputeHistory. This table has the history of the dispute, including where it went and the name of the person who changed the state. Each time the state of the dispute changes a new record is added.

Table UI_BillRouting. This table maps the BAN to the user ID with the BAN indicating who is to be sent the bill. The routing information also indicates when a bill is first processed.

Table UI_DisputeRouting. This table maps the BAN to the user ID with the BAN indicating who is to receive and handle the dispute. This table, which has the User/BAN pairing, states when a dispute was created.

Table UI_ManagerInfo. This table has information about a user, including his employee level and the name of his supervisor. The employee level is used to identify how much (specified in the UI_Threshold table) the user can approve for payment in dollar terms.

Table UI_Threshold. This table identifies a user, with a specified level (specified in the UI_ManagerInfo table), and the threshold that is used to determine the monetary amount he can approve for payment based on the level. A threshold also is recorded to indicate the dollar amount by which the user must receive approval from his manager before granting payment.

Reference tables provide lookup information. Exemplary reference tables are as follows:

R_LERG_NPANXX—contains NPA/NXX data extracted from LERG.

R_LERG_OCN_CATEGORY—OCN category table needed to populate the R_LERG_OCN table.

R_LERG_OCN—contains OCN to Company Name, Virtual OCN, and Virtual Company Name mapping. Virtual OCN and Virtual Company Name are used to map subdivisions to corporate entities (Verizon New England is a company name, Verizon is its virtual company name).

R_PhraseCodeLookup—contains OCC Phrase Codes and the associated description.

UIBINSUBLOOKUP—contains labels for ICTA bins.

DB_VERSION—contains the database build-date (for versioning purposes).

The info tables provide auditing information for invoices and traffic summaries. They provide status information, format, checksum, and other auditing information. For example, Invoiceinfo table for invoices and CDRFileInfo for traffic files are generally used.

A sequence table used to create compatibility between platforms when generating or incrementing the ID (it cannot be atomic with insertion of data).

There are three tables that are used for rate validation. SYS_RATEBOOK, a repository for rate book entries, SYS_RATEVALIDATOR describes the rate validator that is associated with a rate book entry, and SYS_RATEVALIDATORPARAMETER describes the generic parameters used in SYS_RATEBOOK. The SYS_QUANTITYBOOK table maintains the expected unit quantities of a USOC for a BAN. This table is used by quantity validation to determine discrepancies. Entries to this table can be added manually, by CSV import, or by discovery during discrepancy management.

UI Components

User Interface Components. User Interface Components include database objects, OCN lookups, renderer, html encoder, servlets, charts, parameters object, redirector, user object and dynamic menus are designed to be used with the Java Presentation Builder (JPB) tool.

The database object provides a simple wrapper around the standard JDB component database calls. In addition, the database object provides database connection pooling. The db.properties file contains which database to connect to. The database object looks up a particular key in the db.properties file.

The ICTA Binner class is derived from the Database class. It provides the same functionality as the Database class except that the ICTA Binner caches the results. This allows the ICTA Binner to perform many functions without constantly querying the database. Such functions may include, for example: cache of the sum of every column for fast and easy access; calculation the percentage of an item out of the sum of the column; calculate the product of two columns; calculate the ratio of two columns; and the ability to execute two SQL queries and combine the results into one result set

A bin is a logical grouping of data that contains SubID (which translates to text; e.g., carrier name), Peg Count, and MOU (Minutes Of Use). For example in Originating Traffic, “Outbound Traffic Type” is a bin that contains five sub-ids: IntraLATA, InterLATA Intrastate, InterLATA Interstate, Toll Free, Unknown. Bins are very generic and multiple bins can be store in a single database table. All of the ICTA reports use one or more bins per page.

To build ICTA reports, the appropriate bins are assembed. Each bin only differs by an id, and each report will contain one or more of the following objects:

ICTAInnerLoop—Displays a specific bin given a bin id (BinGroupID). A similar object is ICTAInnerLoopAndChart which adds a chart to the report.

ICTAGroup—It is the parent of the inner loop that allows multiple inner loops as children. It also contains the selection criteria, display criteria, and the outer loop.

ICTAOuterLoop—Loops over multiple InnerLoops by Carrier, State, or LATA depending on the display criteria.

ICTAInnerLoopTransit—Same as inner loop except that it access the ICTA transit table.

OCN Lookup is a singleton class that is used to retrieve the virtual company name given an OCN. This class provides a simple static get method for this purpose. This class is used in ICTAjpb. This class is loaded on first use and is stored in the servlets application space (ServletContext). This means that the object is cached in memory and all users will refer to the cached copy. A virtual company name is a name that is extracted from the actual company name. An example of a virtual company name is Verizon. An example of an actual company name is Verizon New Jersey.

The renderer is a class that knows how to render certain types of objects like Strings, Dates, and Numbers (int, float, etc). The renderer is called from JPB. For example, see the Format property of the DatabaseField object in standardlibraryjpb.

The render method takes in a JAVA object, such as String, Date, int, float, double and converts it to a formatted String depending on the given output type. Such output types may include currency—adds a dollar sign ($) and rounds to 2 decimal places (e.g., $8,112.64) and datetime—displays month name, day year (e.g., example: Aug. 4, 2001)

Also, by default the Renderer class assumes output will be for a HTML page. Accordingly, this means that all string output will be HTML encoded. This also works well for PDF documents.

Having described the invention with reference to the presently preferred embodiments, it should be understood that numerous changes in creating and operating such systems and methods may be introduced without departing from the true spirit of the invention as defined in the appended claims.

What is claimed is:

1. A system for determining discrepancies in a communication system comprising:
an invoice management module; and
a validation module.

2. The system according to claim 1, further comprising a reporting module.

3. The system according to claim 1, further comprising a discrepancy analytical module.

4. The system according to claim 1, further comprising an inter-carrier traffic analysis module.

5. The system according to claim 1, wherein the invoice management module provides a repository for invoice activity.

6. The system according to claim 1, wherein the invoice management module manages financial measurements of invoice activity.

7. The system according to claim 1, wherein the validation module validates rate and/or quantity to substantiate costs.

8. The system according to claim 7, wherein costs are substantiated by network element, network feature and/or network usage.

9. The system according to claim 1, wherein the validation module compares an invoiced rate and/or billed rate to a respective cost and/or revenue element.

10. The system according to claim 1, wherein the validation module verifies an accuracy of cost of services.

11. The system according to claim 1, wherein the validation module validates retail and/or wholesale billing systems to ensure accurate billing for services provided.

12. The system according to claim 3, wherein the discrepancy analytical module determines cost discrepancies of a communications network by at least one of a network element, network feature and network usage.

13. The system according to claim 3, wherein the discrepancy analytical module identifies incorrect charges.

14. The system according to claim 13, wherein incorrect charges are identified by relating together at least two of invoice, inventory, usage and billing data.

15. The system according to claim 3, wherein the discrepancy analytical module performs a customized, iterative processing routine based upon a business rule.

16. The system according to claim 2, wherein the reporting module generates a report.

17. The system according to claim 4, wherein the inter-carrier traffic analysis module measures inter-carrier traffic data patterns by analyzing customer call record data and/or usage measurement system data to relate measured traffic data to corresponding invoice data.

18. The system according to claim 17, wherein the patterns include data relating to at least one of a jurisdictional ratio, transit, originating, terminating and time-of-day traffic.

19. The system according to claim 17, wherein the patterns include data relating to at least one of toll-free communications, wireless communications and Internet Service Providers (ISP).

20. The system according to claim 17, wherein the patterns illustrate at least one of peg-count and measurement-of-usage totals and/or percentages.

21. The system according to claim 4, wherein the inter-carrier traffic analysis module comprises at least one inter-carrier traffic analysis processor.

22. A system for determining discrepancies in a communications system comprising:
a first server for maintaining persistent data for the system;
a second server for processing invoice data;
a third server having an application for allowing a user via a user interface to view data; and
a client workstation for accessing the application and user interface to view data.

23. A method for determining discrepancies in a communications network comprising:
retrieving invoice data;
parsing the invoice data into a plurality of first records;
verifying the invoice data in the first records; and
loading the first records into a first database.

24. The method according to claim 23, wherein the data comprises at least one of invoice data and usage data.

25. The method according to claim 24, wherein loading includes acquiring a source file and identifying a type of data of the invoice data.

26. The method according to claim 24, wherein identifying the type of data comprises determining the format, version and carrier of the invoice record.

27. The method according to claim 23, wherein parsing includes:
reading a specification file associated with the type of data of the invoice records; and
dividing the invoice records into a plurality of formatted discrete fields.

28. The method according to claim 27, wherein parsing further includes classifying each invoice record into an invoice record type.

29. The method according to claim 28, wherein parsing further includes generating at least one token for each invoice record.

30. The method according to claim 29, wherein parsing further includes determining a database table to assign each invoice record.

31. The method according to claim 30, wherein the database table comprises an inter-carrier traffic analysis bin.

32. The method according to claim 30, wherein parsing further includes extracting a first field required for the database table from each invoice record.

33. The method according to claim 31, wherein parsing further includes writing the first field to an output file.

34. The method according to claim 32, wherein parsing further includes loading the output file into a primary database.

35. The method according to claim 30, wherein determining the database table for a second record of the first records is made based on a context of at least a third record in proximity to the second record.

36. The method according to claim 30, wherein determining is further based on a context of fourth record in proximity to the second record.

37. The method according to claim 24, further comprising calculating a primary table and a secondary user-interface table.

38. The method according to claim 24, wherein retrieving invoice data comprises requesting the invoice data, accessing the invoice data, verifying specific invoice data, identifying duplicate invoice data, aggregating existing invoice data, formatting data and unloading invoice data.

39. A method for determining discrepancies in a communications system comprising:
retrieving communication data from at least one data source;
parsing the communication data;
analyzing the parsed data; and
reporting a result of the analysis.

40. The method according to claim 39, wherein communication data comprises at least one of network data, billing data and usage data.

41. The method according to claim 39, wherein the data source may comprise at least one of an invoice data source, call record data source and usage data record source.

42. The method according to claim 39, wherein parsing comprises breaking the communication data down into a plurality of corresponding records and usage files which describe a structure and form of the communication data.

43. The method according to claim 42, wherein parsing also include enriching the communication data with reference data.

44. The method according to claim 43, wherein reference data includes at least one of tariff and rate information.

45. The method according to claim 42, further comprising storing the plurality of records on a relational database.

46. The method according to claim 39, wherein analyzing the parsed data comprises applying at least one business rule to correlate cost objects to corresponding revenue objects.

47. The method according to claim 39, wherein analyzing the parsed data comprises applying at least one business rule to correlate business objects to corresponding revenue, cost and/or margin objects.

48. The method according to claim 47, wherein business objects comprise at least one of customer objects, service objects and product objects.

49. The method according to claim 39, wherein reporting comprises presenting a result of the analyze step.

50. A system for determining discrepancies of a communication system comprising:
at least one data source;
at least one data parser and/or data adaptor;
at least one data loader and/or data abstractor;
at least one database abstraction;
at least one data store;
an invoice management module;
a revenue and cost management module;
an intercarrier traffic management module;
a secondary user-interface table; and
a user interface.

51. A system for determining discrepancies in a communications network comprising:
retrieving means for retrieving invoice data;
parsing means for parsing the invoice data into a plurality of first records;
verifying means for verifying the invoice data in the first records; and
loading means for loading the first records into a first database.

52. The system according to claim 51, wherein the loading means includes acquiring means for acquiring a source file and identifying means for identifying a type of data of the invoice data.

53. The system according to claim 52, wherein the identifying means comprises determining means for determining the format, version and carrier of the invoice record.

54. The system according to claim 51, wherein the parsing means includes:
reading means for reading a specification file associated with the type of data of the invoice records; and
dividing means for dividing the invoice records into a plurality of formatted discrete fields.

55. A computer readable medium having computer instructions provided thereon for enabling a computer system to perform a method for determining discrepancies in a communications network, the method comprising:
retrieving invoice data;
reading a specification file associated with the type of data of the invoice data;
dividing the invoice data into a plurality of first records;
verifying the invoice data in the first records;
acquiring a source file;
determining a format, version and/or carrier of the invoice data; and
loading the first records into a database.

56. A computer application program operable on a computer for performing a method for determining discrepancies in a communications network, the method comprising:
retrieving invoice data;
reading a specification file associated with the type of data of the invoice data;
dividing the invoice data into a plurality of first records;
verifying the invoice data in the first records;
acquiring a source file;
determining a format, version and/or carrier of the invoice data; and
loading the first records into a database.

57. A system for determining discrepancies in a communications system comprising:
retrieving means for retrieving communication data from at least one data source;
parsing means for parsing the communication data;
analyzing means for analyzing the parsed data; and
reporting means for reporting a result of the analysis.

58. A computer readable medium including computer instructions for enabling a computer system to perform a method for determining discrepancies in a communications system, the method comprising:
retrieving communication data from at least one data source;
parsing the communication data;
analyzing the parsed data; and
reporting a result of the analysis.

59. An application program operable on a computer system for performing a method for determining discrepancies in a communications system, the method comprising:
retrieving communication data from at least one data source;
parsing the communication data;
analyzing the parsed data; and
reporting a result of the analysis.
